(19) United States
(12) Patent Application Publication
(10) Pub. No.: US 2022/0036101 A1
(43) Pub. Date: Feb. 3, 2022

(54) METHODS, SYSTEMS AND COMPUTER PROGRAM PRODUCTS FOR DRIVER MONITORING

(71) Applicant: Arnav Gupta, Fremont, CA (US)

(72) Inventor: Arnav Gupta, Fremont, CA (US)

(21) Appl. No.: 17/503,525

(22) Filed: Oct. 18, 2021

(51) Int. Cl. G06K 9/00; B60W 40/08; B60W 50/00

(52) U.S. Cl. CPC G06K 9/00845; G06K 9/00604; G06K 9/00926; B60W 40/08; B60W 2540/229; B60W 2040/0818; B60W 2050/0054; B60W 2540/221; B60W 50/0098

(57) ABSTRACT

The invention enables assessment and monitoring of attentiveness of a driver of a vehicle. The invention provides systems, methods and computer program products that determine a driver specific baseline degree of eye openness for a vehicle driver, and thereafter monitor and determine driver attentiveness or alertness based on the determined driver specific baseline degree of eye openness.

### FIELD OF THE INVENTION

The invention relates to the domain of vehicle monitoring. In particular, the invention provides methods, systems and computer program products for monitoring a degree of attentiveness of a driver of a vehicle.

### BACKGROUND

Driver monitoring systems are being increasingly adopted for safety and security within vehicles.

FIG. 1 illustrates an exemplary driver monitoring system 100—which comprises a sensor system 102, a monitoring system 104 and an alert generation system 106, coupled with each other. The sensor system 102 comprises one or more cameras and/or other state sensors or environment sensors positioned within a vehicle interior, that can be used to detect or monitor occupants therewithin. Monitoring system 104 may be coupled with sensor system 102 and may be configured to receive driver state parameters or environment state parameters captured by the camera(s) and/or other sensors within sensor system 102. The monitoring system 104 may be configured such that state parameters received from the sensor system 102 may be periodically or continually analyzed to determine occurrence of alarm events. For example, in driver monitoring system 100, alarm events may comprise any of driver drowsiness, driver inattention, driver or passenger discomfort, or other risk events. In case the monitoring system 104 detects an alarm event or a risk event (for example, any of driver drowsiness, driver inattention, or driver discomfort), an appropriate state signal may be transmitted to alert generation system 106—wherein alert generation system 106 is configured to respond by raising an appropriate alarm or taking remedial action. For example, if driver is detected to be drowsy and also does not respond to an alarm, the autopilot system of the vehicle may take over the vehicle driving control and park the vehicle safely.

Driver monitoring systems based on monitoring of a subject's eye have been found to be effective and reasonably straightforward to implement. By monitoring a degree of openness of a subject's eye in real time, monitoring systems can determine whether a driver is fully alert, or is drowsy, or un-alert or un-attentive. For example, if the driver's eye is found to be sufficiently open (i.e. when compared to a predefined threshold of eye openness) it may be concluded that the driver is awake and alert, whereas if the driver's eye is found to be insufficiently open (i.e. when compared to the predefined threshold of eye openness) it may be reasonably concluded that the driver is drowsy or insufficiently alert.

It has however been found that the degree of openness that each individual person's eye conforms to during an alert state or a fully awake state, is based on the individual's facial characteristics, facial structure, and eye characteristics—and can vary quite significantly across individuals. Thus while for some individuals having characteristically ‘large’ eyes, the degree of openness of an eye during an alert or fully awake state may be quite large, for other individuals having characteristically ‘small’ or ‘narrow’ eyes, the degree of openness of an eye even during an alert or fully awake state may be much smaller. Comparing a real time degree of eye openness against predefined thresholds can therefore be misleading and may lead to detection of ‘false positives’.

Additionally, in cases where an individual's eye has a relatively lower degree of openness even in an alert or awake state, the visible area of the subject's eye even in a fully open state may be insufficient for the purposes of real time driver monitoring.

There is accordingly a need for eye based driver monitoring solutions that enable monitoring of driver attentiveness or alertness and that also address the above problems.

### SUMMARY

The invention provides eye based driver monitoring solutions that enable accurate monitoring of driver attentiveness or alertness notwithstanding variations in the default degree of eye openness across individuals.

The invention provides a method for monitoring a degree of attentiveness for a driver of a vehicle. The method comprises (i) detecting a predefined vehicle operation event, (ii) responsive to detecting the predefined vehicle operation event, initiating a session specific driver enrolment process for the driver, comprising (a) acquiring at least one baseline eye image of the driver, (b) determining baseline eye openness of the driver based on image information within the at least one baseline eye image, (c) prior to detection of a predefined session termination event (1) acquiring a set of images of the driver, (2) determining real time eye openness of the driver based on image information within the acquired set of images, (3) determining a difference value representing a difference between the real time eye openness of the driver and the baseline eye openness of the driver, and (4) generating a data signal triggering a state change in response to determining that the difference value is greater than a threshold value.

In an embodiment of the method as claimed in claim 1, the at least one baseline eye image is acquired by an image sensor within a defined duration from detection of the predefined operation event.

In another embodiment of the method, the predefined vehicle operation event is any one of a vehicle ignition event, a vehicle autopilot or cruise control mode engagement event, a driver seat occupation event, changing gear or driving mode, changing settings, interacting with map or infotainment system, the driver opening a driver-side door to enter the vehicle, the driver closing the driver's-side door after occupying the driver's seat, the driver engaging the gear shift for the first time after engine ignition or after occupying the driver's seat, or the driver engaging the accelerator or brake for the first time after engine ignition or after occupying the driver's seat.

In a method embodiment, the predefined session termination event is any one of a vehicle engine shut-off event, a vehicle autopilot mode disengagement event, a driver's seat vacation event, the driver opening the vehicle's driver-side door to exit the vehicle, the driver vacating a driver's seat, the driver closing the driver's-side door after vacating the driver's seat, the driver disengaging the gear shift prior to shutting off the vehicle engine or prior to vacating the driver's seat, or the driver engaging the brake prior to shutting off the vehicle engine.

In a further method embodiment, the state change triggered by the data signal comprises any of (i) change from a non-alarm state to an alarm state, (ii) change from an engine-on state to an engine-off state, (iii) change to a vehicle deceleration or a vehicle braking state, or (iv) change from one of a vehicle autopilot engaged state or a vehicle autopilot disengaged state to the other of the vehicle autopilot engaged state or a vehicle autopilot disengaged state.

The invention additionally provides a method for monitoring a degree of attentiveness for a driver of a vehicle, the method (i) comprising detecting a predefined vehicle operation event, (ii) responsive to detecting the predefined vehicle operation event, initiate a session specific driver enrolment process for the driver, comprising (a) acquiring at least one baseline image of the driver, and responding to determining that the at least one baseline image complies with a set of predefined requirements by (1) determining baseline eye openness of the driver based on the eye image information within the at least one baseline image, (2) determining a difference value representing a difference between the baseline eye openness of the driver and a threshold value for eye openness of the driver, and (3) selecting between a first driver monitoring mode and a second driver monitoring mode, wherein the selection is based on the difference value. In the first driver monitoring mode, driver alertness may be determined based on image characteristics corresponding to the driver's eye. In the second driver monitoring mode, driver alertness may be determined based on one or more detected non-eye related characteristics of the driver.

An embodiment of this method may include responding to determining that the at least one baseline image does not comply with the set of predefined requirements, by implementing the second driver monitoring mode.

In another method embodiment, the at least one baseline image is acquired by an image sensor within a defined duration from detection of the predefined operation event.

In a specific method embodiment, the predefined operation event is any one of a vehicle ignition event, a vehicle autopilot mode engagement event, a driver seat occupation event, changing gear or driving mode, changing settings, interacting with map or infotainment system, the driver opening a driver-side door to enter the vehicle, the driver closing the driver's-side door after occupying the driver's seat, the driver engaging the gear shift for the first time after engine ignition or after occupying the driver's seat, or the driver engaging the accelerator or brake for the first time after engine ignition or after occupying the driver's seat.

In an embodiment of the method, the non-eye related characteristics of the driver includes one or more of head motion, mouth movement, heart rate, pulse rate, respiration rate, capacitive sensor response, electrocardiograph response, and galvanic skin response,

In a particular method embodiment, responsive to selection of the first driver monitoring mode, the method comprises implementing, prior to detection of a predefined session termination event, the steps of (i) acquiring a set of images of the driver, (ii) determining real time eye openness of the driver based on image information within the acquired set of images, (iii) determining a difference value representing a difference between the real time eye openness of the driver and the baseline eye openness of the driver, and (iv) generating a data signal triggering a state change in response to determining that the difference value is greater than a threshold value.

In one embodiment of this method, a the predefined session termination event is any one of a vehicle engine shut-off event, a vehicle autopilot mode disengagement event, a driver's seat vacation event, the driver opening the vehicle's driver-side door to exit the vehicle, the driver vacating a driver's seat, the driver closing the driver's-side door after vacating the driver's seat, the driver disengaging the gear shift prior to shutting off the vehicle engine or prior to vacating the driver's seat, or the driver engaging the brake prior to shutting off the vehicle engine.

In a particular method embodiment, the state change triggered by the data signal comprises any of (i) change from a non-alarm state to an alarm state, (ii) change from an engine-on state to an engine-off state, (iii) change to a vehicle deceleration or a vehicle braking state, or (iv) change from one of a vehicle autopilot engaged state or a vehicle autopilot disengaged state to the other of the vehicle autopilot engaged state or a vehicle autopilot disengaged state.

The method also includes an, wherein responsive to selection of the second driver monitoring mode, the method comprises implementing, prior to detection of a predefined session termination event, the steps of (i) acquiring data representing non-eye related characteristics of the driver, (ii) determining based on the acquired data, one or more alertness parameters corresponding to the driver, wherein the non-eye related characteristics of the driver includes one or more of head motion, mouth movement, heart rate, pulse rate, respiration rate, capacitive sensor response, electrocardiograph response, and galvanic skin response, and (iii) generating a data signal triggering a state change based on one or more of the determined alertness parameters.

The invention provides a system for monitoring a degree of attentiveness for a driver of a vehicle. The system comprises a memory and a processor. The processor may be configured to implement the steps of (i) detecting a predefined vehicle operation event, (ii) responsive to detecting the predefined vehicle operation event, initiating a session specific driver enrolment process for the driver, comprising (a) acquiring at least one baseline eye image of the driver, (b) determining baseline eye openness of the driver based on image information within the at least one baseline eye image, (c) prior to detection of a predefined session termination event (1) acquiring a set of images of the driver, (2) determining real time eye openness of the driver based on image information within the acquired set of images, (3) determining a difference value representing a difference between the real time eye openness of the driver and the baseline eye openness of the driver, and (4) generating a data signal triggering a state change in response to determining that the difference value is greater than a threshold value.

The system may be configured such that at least one baseline eye image is acquired by an image sensor within a defined duration from detection of the predefined operation event.

In an embodiment, the system may be configured such that, the predefined operation event is any one of a vehicle ignition event, a vehicle autopilot mode engagement event, a driver's seat occupation event, the driver opening a driver-side door to enter the vehicle, the driver closing the driver's-side door after occupying the driver's seat, the driver engaging the gear shift for the first time after engine ignition or after occupying the driver's seat, or the driver engaging the accelerator or brake for the first time after engine ignition or after occupying the driver's seat.

In another embodiment, the system may be configured such that the predefined session termination event is any one of a vehicle engine shut-off event, a vehicle autopilot mode disengagement event, a driver's seat vacation event, the driver opening the vehicle's driver-side door to exit the vehicle, the driver vacating a driver's seat, the driver closing the driver's-side door after vacating the driver's seat, the driver disengaging the gear shift prior to shutting off the vehicle engine or prior to vacating the driver's seat, or the driver engaging the brake prior to shutting off the vehicle engine.

In a further embodiment of this system, the system may be configured such that, the state change triggered by the data signal comprises any of (i) change from a non-alarm state to an alarm state, (ii) change from an engine-on state to an engine-off state, (iii) change to a vehicle deceleration or a vehicle braking state, or (iv) change from one of a vehicle autopilot engaged state or a vehicle autopilot disengaged state to the other of the vehicle autopilot engaged state or a vehicle autopilot disengaged state.

The invention additionally provides a system for monitoring a degree of attentiveness for a driver of a vehicle. The system comprises a memory and a processor. The processor is configured for (i) detecting a predefined vehicle operation event, (ii) responsive to detecting the predefined vehicle operation event, initiate a session specific driver enrolment process for the driver, comprising (a) acquiring at least one baseline image of the driver, and responding to determining that the at least one baseline image complies with a set of predefined requirements by (1) determining baseline eye openness of the driver based on the eye image information within the at least one baseline image, (2) determining a difference value representing a difference between the baseline eye openness of the driver and a threshold value for eye openness of the driver, and (3) selecting between a first driver monitoring mode and a second driver monitoring mode, wherein the selection is based on the difference value. In the first driver monitoring mode, driver alertness is determined based on image characteristics corresponding to the driver's eye. In the second driver monitoring mode, driver alertness is determined based on one or more detected non-eye related characteristics of the driver.

In an embodiment of this system, the system is configured to respond to determining that the at least one baseline image does not include comply with the set of predefined requirements, by implementing the second driver monitoring mode.

The system may be configured such that the at least one baseline eye image is acquired by an image sensor within a defined duration from detection of the predefined operation event.

In an embodiment, the system may be configured such that, the predefined operation event is any one of a vehicle ignition event, a vehicle autopilot mode engagement event, a driver seat occupation event, changing gear or driving mode, changing settings, interacting with map or infotainment system, the driver opening a driver-side door to enter the vehicle, the driver closing the driver's-side door after occupying the driver's seat, the driver engaging the gear shift for the first time after engine ignition or after occupying the driver's seat, or the driver engaging the accelerator or brake for the first time after engine ignition or after occupying the driver's seat.

In another embodiment, the system may be configured such that the non-eye related characteristics of the driver includes one or more of head motion, mouth movement, heart rate, pulse rate, respiration rate, capacitive sensor response, electrocardiograph response, and galvanic skin response,

In a particular embodiment, the system may be configured to respond to selection of the first driver monitoring mode, by implementing, prior to detection of a predefined session termination event, the steps of (i) acquiring a set of images of the driver, (ii) determining real time eye openness of the driver based on image information within the acquired set of images, (iii) determining a difference value representing a difference between the real time eye openness of the driver and the baseline eye openness of the driver; and (iv) generating a data signal triggering a state change in response to determining that the difference value is greater than a threshold value.

In an embodiment, the system is configured such that, the predefined session termination event is any one of a vehicle engine shut-off event, a vehicle autopilot mode disengagement event, a driver's seat vacation event, the driver opening the vehicle's driver-side door to exit the vehicle, the driver vacating a driver's seat, the driver closing the driver's-side door after vacating the driver's seat, the driver disengaging the gear shift prior to shutting off the vehicle engine or prior to vacating the driver's seat, or the driver engaging the brake prior to shutting off the vehicle engine.

In another embodiment, the system is configured such that the state change triggered by the data signal comprises any of (i) change from a non-alarm state to an alarm state, (ii) change from an engine-on state to an engine-off state, (iii) change to a vehicle deceleration or a vehicle braking state, or (iv) change from one of a vehicle autopilot engaged state or a vehicle autopilot disengaged state to the other of the vehicle autopilot engaged state or a vehicle autopilot disengaged state.

In a further embodiment, the system is configured to respond to selection of the second driver monitoring mode, by implementing, prior to detection of a predefined session termination event, the steps of (i) acquiring data representing non-eye related characteristics of the driver, (ii) determining based on the acquired data, one or more alertness parameters corresponding to the driver, wherein the non-eye related characteristics of the driver includes one or more of head motion, mouth movement, heart rate, pulse rate, respiration rate, capacitive sensor response, electrocardiograph response, and galvanic skin response, and (iii) generating a data signal triggering a state change based on one or more of the determined alertness parameters.

The invention provides a computer program product for monitoring a degree of attentiveness for a driver of a vehicle, comprising a non-transitory computer readable medium having a computer readable program code embodied therein. The computer readable program code comprising instructions for (i) detecting a predefined vehicle operation event, (ii) responsive to detecting the predefined vehicle operation event, initiating a session specific driver enrolment process for the driver, comprising (a) acquiring at least one baseline eye image of the driver, (b) determining baseline eye openness of the driver based on image information within the at least one baseline eye image, (c) prior to detection of a predefined session termination event (1) acquiring a set of images of the driver, (2) determining real time eye openness of the driver based on image information within the acquired set of images, (3) determining a difference value representing a difference between the real time eye openness of the driver and the baseline eye openness of the driver, and (4) generating a data signal triggering a state change in response to determining that the difference value is greater than a threshold value.

The invention additionally provides a computer program product for monitoring a degree of attentiveness for a driver of a vehicle, comprising a non-transitory computer readable medium having a computer readable program code embodied therein. The computer readable program code comprising instructions for (i) detecting a predefined vehicle operation event, (ii) responsive to detecting the predefined vehicle operation event, initiate a session specific driver enrolment process for the driver, comprising (1) acquiring at least one baseline image of the driver, and responding to determining that the at least one baseline image complies with a set of predefined requirements by (a) determining baseline eye openness of the driver based on the eye image information within the at least one baseline image, (b) determining a difference value representing a difference between the baseline eye openness of the driver and a threshold value for eye openness of the driver, and (c) selecting between a first driver monitoring mode and a second driver monitoring mode, wherein the selection is based on the difference value. In the first driver monitoring mode, driver alertness may be determined based on image characteristics corresponding to the driver's eye. In the second driver monitoring mode, driver alertness may be determined based on one or more detected non-eye related characteristics of the driver.

The computer program product according to the present invention may be configured to perform any one or more of the specific method embodiments of the invention that are described in the following written description.

### BRIEF DESCRIPTION OF THE ACCOMPANYING DRAWINGS

FIG. 1 illustrates a system of a kind that may be used for driver monitoring systems.

FIG. 2 illustrates a first method of determining driver attentiveness in accordance with the teachings of the present invention.

FIG. 3 illustrates another method of determining driver attentiveness in accordance with the teachings of the present invention.

FIG. 4 illustrates an exemplary system that may be configured for assessing and determining driver attentiveness, in accordance with the teachings of the present invention.

FIG. 5 illustrates an exemplary system for implementing the present invention.

### DETAILED DESCRIPTION

The invention enables assessment and monitoring of attentiveness of a driver of a vehicle. The invention provides systems, methods and computer program products that determine a driver-specific baseline degree of eye openness for a vehicle driver, and thereafter monitors and determines driver attentiveness or alertness based on the determined driver-specific baseline degree of eye openness.

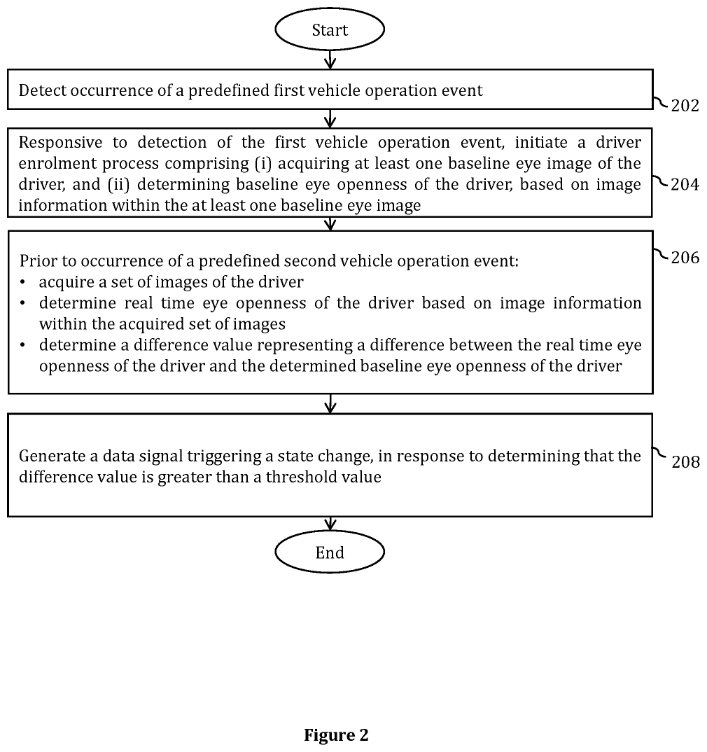

FIG. 2 illustrates a first method of determining driver attentiveness in accordance with the teachings of the present invention. The method of FIG. 2 seeks to address the problem that the degree of openness that each individual's eye conforms to during an alert or fully awake state, is based on the individual's facial characteristics, facial structure, and eye characteristics—and can vary quite significantly across individuals. The method as described below enables normalizing of such variations and enables assessment of a degree of eye openness in a manner that takes into account such variations.

Step 202 comprises detecting an occurrence of a predefined first vehicle operation event. The predefined first vehicle operation event may comprise any vehicle operation event that could be understood to be associated with a state where the vehicle's driver is in a state of alertness. By way of non-limiting examples of the predefined first vehicle operation event, a driver opening the vehicle's driver-side door to enter the vehicle, a driver occupying the driver's-side seat, a driver closing the driver's-side door after occupying the driver's seat, a driver initiating engine ignition, a driver engaging the gear shift for the first time after engine ignition or after occupying the driver's seat, a driver engaging the accelerator or brake for the first time after engine ignition or after occupying the driver's seat, or a vehicle autopilot mode engagement event—are all events at which a driver may be expected to be in a state of alertness (since these events occur close to commencement of the driving session or trip—and may therefore be used as the predefined first vehicle operation event). It is generally expected that driver alertness or attentiveness could reduce during a driving session or trip. However, at any events of the type described above (and which typically occur at or close to the commencement of the driving session or trip), the driver would likely be at her/his most alert or attentive state in the given circumstances, and her/his eye openness is likely to be at the maximum or at close to the maximum possible in those circumstances.

Step 204 comprises responding to detection of the predefined first vehicle operation event, by initiating a driver enrolment process comprising (i) acquiring at least one baseline eye image of the driver, and (ii) determining baseline eye openness of the driver, based on image information within at least one baseline eye image. The baseline eye openness represents a degree of eye openness of a driver, that is determined during the enrollment process. Since the enrollment process is implemented in response to detecting an event that occurs at or close to the start of a drive session or trip, the driver is considered to be in a state of alertness or attentiveness, and eye openness at such event is likely to be the maximum (or close to the maximum) possible eye openness of the driver for the drive session.

In an embodiment of the method, each of the one or more baseline eye images of the driver are acquired by an image sensor. Further, each of the one or more baseline eye images may be obtained within a defined duration from detection of the predefined operation event.

For the purposes of the method of FIG. 2, as well as the remaining method and system embodiments of the present invention, it would be understood that there can be several different approaches to determining eye openness—and any of such methods can be implemented for the purposes of the present invention. For example, in certain methods, determining eye openness may involve receiving a face image as input, extracting features around an eye (e.g., or both eyes), and using an algorithm to determine whether an eye is open or closed and the corresponding degree of openness. In one exemplary method, determining a degree of eye openness may involve capturing real time eye openness image data using an image sensor, and estimating a degree of eye openness based on the real time eye openness image data and a set of synthetic eye openness image data including known levels of eye openness. In another exemplary method, determining a degree of eye openness may involve (i) assessing within real time eye image data parameters, such as a distance between the upper eyelid and lower eyelid, or visible surface area or visible outlines of portions of an eye (such as the iris, or cornea, or eyeball) and (ii) comparing the assessed real time eye image data parameters against predefined threshold parameter values that are associated with an average human eye.

Each of step 204, and subsequent step 206 of the method of FIG. 2 is implemented prior to occurrence of a predefined second vehicle operation event. The predefined second vehicle operation event may comprise any vehicle operation event that could be understood to be associated with an end of a driving session or trip. By way of non-limiting examples of a predefined second vehicle operation event, the driver opening the vehicle's driver side door to exit the vehicle, the driver vacating the driver's side seat, the driver closing the driver's side door after vacating the driver's seat, the driver shutting off the vehicle engine, the driver disengaging the gear shift prior to shutting off the vehicle engine or prior to vacating the driver's seat, the driver engaging the brake prior to shutting off the vehicle engine, or a vehicle autopilot mode disengagement event—are all events that may be expected to signify the end of a driving session or trip, and which may therefore be used as a predefined second vehicle operation event. By implementing steps 204 and 206 between the predefined first vehicle operation event and predefined second vehicle operation event, the invention ensures that each determination of baseline eye openness of a vehicle driver is personalized or specific to a driving session or trip—and is therefore as accurate as possible in real time.

Step 206 comprises implementing, prior to occurrence of a predefined second vehicle operation event, the steps of (i) acquiring a set of images of the driver, (ii) determining real time eye openness of the driver based on image information within the acquired set of images, and (iii) determining a difference value representing a difference between the real time eye openness of the driver and the determined baseline eye openness of the driver (that was previously determined at step 204).

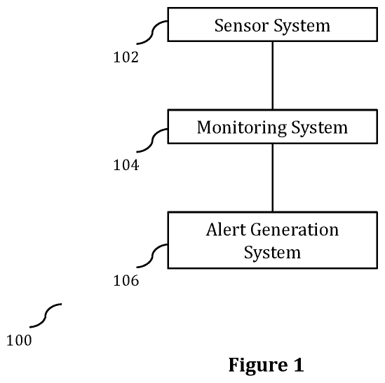

Step 208 comprises generating a data signal triggering a state change, in response to determining that the difference value (determined at step 206) is greater than a threshold value. The threshold value used at step 208 may comprise any predefined value or range of values that represents a maximum acceptable or safe difference between baseline eye openness and real time eye openness. In the event the difference between a determined baseline eye openness and a determined real time eye openness of a vehicle driver exceeds this threshold value, the difference would be considered unacceptable, resulting in a determination that the vehicle's driver is unacceptably un-alert or un-attentive. The data signal may be transmitted to an alert generation system (for example, alert generation system 106 in FIG. 1)—wherein the alert generation system is configured to respond by raising an appropriate alarm or taking remedial action. For example, if it is determined that the vehicle's driver is drowsy and the driver also does not respond to an alarm, the autopilot system of the vehicle may take over the vehicle driving control and park the vehicle safely. In various specific embodiments, the data signal at step 208 may trigger a state change comprising any of (i) a change from a non-alarm state to an alarm state, (ii) a change from an engine-on state to an engine-off state, (iii) change to a vehicle deceleration or a vehicle braking state, or (iv) change from one of a vehicle autopilot engaged state or a vehicle autopilot disengaged state to the other of the vehicle autopilot engaged state or a vehicle autopilot disengaged state.

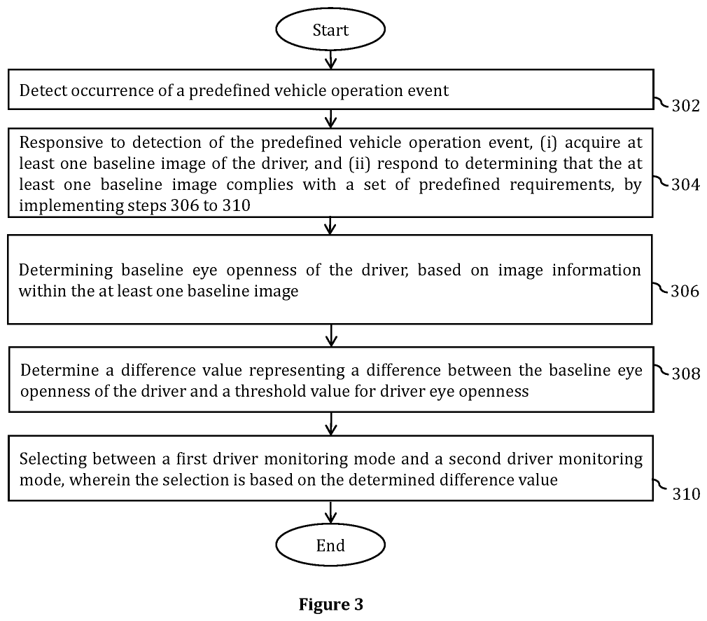

FIG. 3 illustrates another method of determining driver attentiveness in accordance with the teachings of the present invention.

The method of FIG. 3 provides a solution to the problem where due to facial characteristics, an individual's eye has a relatively lower degree of openness even in an alert or awake state, such that the visible area of the subject's eye even in a fully open state may be insufficient for the purposes of real time driver monitoring.

Step 302 comprises detecting occurrence of a predefined vehicle operation event. As described in connection with FIG. 2, the predefined vehicle operation event may comprise any vehicle operation event that could be understood to be associated with a state where the vehicle's driver is in a state of alertness or even maximum possible alertness. By way of non-limiting examples of the predefined vehicle operation event, the driver opening the vehicle's driver side door to enter the vehicle, the driver occupying the driver's side seat, the driver closing the driver's side door after occupying the driver's seat, the driver initiating engine ignition, the driver engaging the gear shift for the first time after engine ignition or after occupying the driver's seat, the driver engaging the accelerator or brake for the first time after engine ignition or after occupying the driver's seat, or a vehicle autopilot mode engagement event—are all events at which a driver may be expected to be in a state of alertness or maximum possible alertness for the duration of the driving session or trip, and which may therefore be used as the predefined vehicle operation event. It is generally expected that driver alertness or attentiveness can reduce during a driving session or trip. However, at any events of the type described above (and which typically occur at or close to the commencement of the driving session or trip), the driver would likely be at maximum possible alertness or attentiveness (or at the very least would be in an alert state), and her/his eye openness is likely to be at the maximum or at close to the maximum.

Step 304 comprises responding to detection of the predefined vehicle operation event, by acquiring at least one baseline image of the driver. The method thereafter involves determining whether the at least one baseline image complies with a set of predefined requirements. The set of predefined requirements may include any one or more of (i) a requirement that the baseline image includes eye image information corresponding to at least one eye, (ii) a requirement that eye image information within the baseline image is sufficient for determining a degree of openness of an eye to which the eye image information corresponds, and (iii) a requirement that the image information within the baseline image is sufficient for implementing any of the subsequent methods steps 306 to 310. Responsive to determining that the at least one baseline image complies with a set of predefined requirements, the method involves implementing steps 306 to 310 that are described in more detail below.

Step 306 comprises determining baseline eye openness of the driver, based on image information within the at least one baseline eye image. The baseline eye openness represents a degree of eye openness of a driver in an alert state, that is determined during the enrollment process. Since the enrollment process is implemented in response to detecting an event that occurs at or close to the start of a drive session or trip, the driver is considered to be in a state of alertness or attentiveness, and eye openness at such event is likely to be at or close to the maximum possible eye openness of the driver for the drive session.

In an embodiment of the method, each of the one or more baseline eye images of the driver are acquired by an image sensor. Further, each of the one or more baseline eye images may be obtained within a defined duration from detection of the predefined operation event.

As described previously in connection with FIG. 2, for the purposes of the method of FIG. 3, there can be several different approaches to determining eye openness—and any of such methods can be implemented for the purposes of the present invention (including any of the specific methods described briefly hereinabove).

Step 308 comprises determining a difference value representing a difference between the baseline eye openness of the driver and a threshold value for driver eye openness. The threshold value for driver eye openness may comprise any prescribed value or range of values that represent a minimum degree of eye openness required for accurate or safe monitoring of driver alertness or driver attentiveness. In other words, degrees of driver eye openness that fall below (or significantly below) the threshold value may be insufficient for determining whether a driver of a vehicle is in an alert/attentive state or in an un-alert or un-attentive state. In an embodiment, the threshold value may comprise 40% or 30% or 20%.

Step 310 comprises selecting between a first driver monitoring mode and a second driver monitoring mode, wherein the selection is based on the difference value that has been determined at step 308.

In a specific embodiment, (i) responsive to the difference value (that represents a difference between the baseline eye openness of the driver and a threshold value for driver eye openness) falling within a prescribed range of acceptable difference values, step 310 comprises selecting a first driver monitoring mode, whereas (ii) responsive to the difference value (that represents a difference between the baseline eye openness of the driver and a threshold value for driver eye openness) falling outside a prescribed range of acceptable difference values, step 310 comprises selecting a second driver monitoring mode. In the first driver monitoring mode, driver alertness is determined based on image characteristics corresponding to the driver's eye. In the second driver monitoring mode, driver alertness is determined based on one or more detected non-eye related characteristics of the driver—which characteristics may be based either on state data received from an image sensor or on state data received from non-image sensors.

In an embodiment of the invention, method step 304 comprises responding to a determination that the at least one baseline image does not include eye image information does not comply with the set of predefined requirements, by selecting the second driver monitoring mode for implementation.

In a specific embodiment of the method of FIG. 3, in the first driver monitoring mode, driver alertness is determined based on a degree of eye openness of the vehicle driver. In a yet more specific embodiment, implementing the first driver monitoring mode may comprise implementing one or more, and preferably all of the steps of the method of FIG. 2.

In another specific embodiment, in the second driver monitoring mode, driver alertness is determined based on image sensing and analysis of facial expressions, or of positioning or posture of the head, face or body of the driver, or alternatively on state data received from non-image sensors. For example, image sensor data that results in detection of a nodding motion of the driver's head, or uncharacteristic relaxation of the driver's facial muscles, or a slumped posture of the driver, may individually or collective result in a determination that a vehicle driver is un-alert or un-attentive or drowsy. In yet another embodiment, in the second driver monitoring mode, driver alertness is determined based on sensing and/or detection or one or more of head motion, mouth movement, heart rate, pulse rate, respiration rate, capacitive sensor response, electrocardiograph response, galvanic skin response, or any other non-eye related physiological or behavioral parameters of the vehicle driver.

In a particular embodiment of the method of FIG. 3, responsive to selection of the second driver monitoring mode, the method comprises implementing, prior to detection of a predefined session termination event, the steps of (i) acquiring data representing non-eye related characteristics of the driver, (ii) determining based on the acquired data, one or more alertness parameters corresponding to the driver, wherein the non-eye related characteristics of the driver includes one or more of head motion, mouth movement, heart rate, pulse rate, respiration rate, capacitive sensor response, electrocardiograph response, and galvanic skin response, and (iii) generating a data signal triggering a state change in response to a determination (based on one or more of the determined alertness parameters) that the driver is insufficiently alert or attentive or is un-alert or un-attentive.

The predefined session termination event may comprise any of the driver opening the vehicle's driver's-side door to exit the vehicle, the driver vacating the driver's-side seat, the driver closing the driver's-side door after vacating the driver's seat, the driver shutting off the vehicle engine, the driver disengaging the gear shift prior to shutting off the vehicle engine or prior to vacating the driver's seat, the driver engaging brake prior to shutting off the vehicle engine, or a vehicle autopilot mode disengagement event.

4 illustrates an exemplary system that may be configured for assessing and determining driver attentiveness, in accordance with the teachings of the present invention.

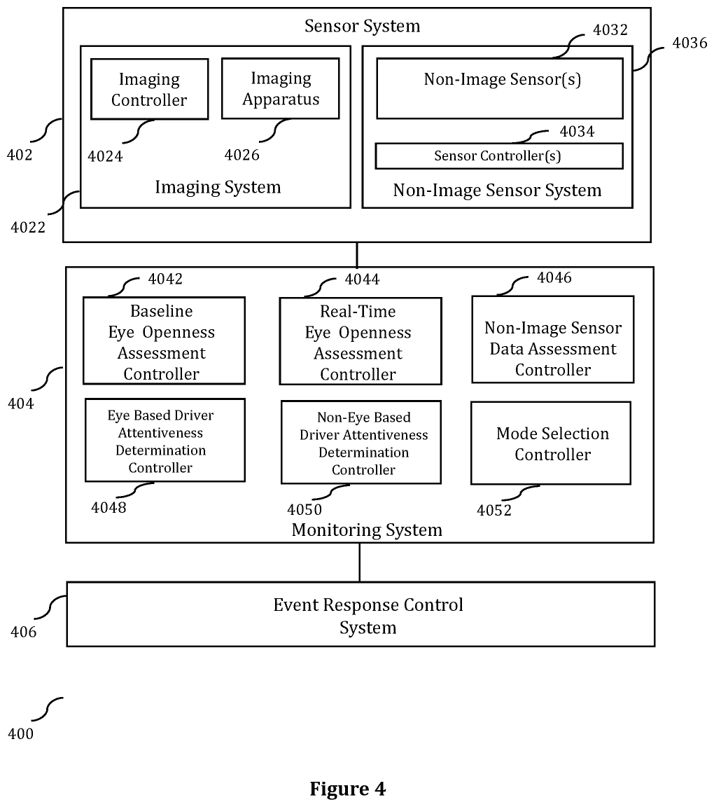

FIG. 4 illustrates an exemplary system 400 according to the present invention for performing driver monitoring.

System 400 comprises a sensor system 402, a monitoring system 404, and an event response control system 406.

Sensor system 402 comprises an imaging system 4022 and optionally a non-image sensor system 4036. Imaging system 4022 comprises an imaging controller 4024 and an imaging apparatus 4026. Imaging apparatus 4026 may comprise one or more cameras or image sensors positioned to capture images of a field of view that is intended to be monitored. Imaging apparatus 4026, and the acquisition of images through imaging apparatus 4026 may be controlled by imaging controller 4024—which may comprise a processor implemented controller configured for controlling the operation and operating parameters of imaging apparatus 4026. In various embodiments, imaging controller 4024 may be configured to control one or more of aperture, shutter speed, integration time, optical zoom, digital zoom, optical filtering, and image acquisition functionality of imaging apparatus 4026. The imaging system 4022 may be used to acquire images for the purposes of implementing any one or more of the methods of FIGS. 2 and 3 as described above.

Non-image sensor system 4036 comprises at least a first non-image sensor 4032 (i.e. a sensor configured to capture state data that is not image data). In various embodiments, the non-image sensor 4032 may comprise a sensor configured to detect any of heart rate, pulse rate, respiration rate, capacitive sensor response, electrocardiograph response, galvanic skin response. Non-image sensor system 4036 additionally includes at least one sensor controller 4034 comprising a processor implemented controller configured for controlling the operation and operating parameters of the non-image sensor 4032.

In an embodiment, imaging controller 4024 and sensor controller 4034 may be directly or indirectly communicably coupled with each other, to enable system 400 to switch between a first eye-based (i.e. image based) driver monitoring mode and a second non-eye based driver monitoring mode (wherein the non-eye based driver monitoring mode relies on non-image sensor 4032)—for example, for implementing the method steps of the method of FIG. 3.

Monitoring system 404 may be coupled with sensor system 402 and may be configured to receive image data captured by a camera or image sensor within imaging system 4022 and/or non-image state data captured by a non-image sensor 4032 within non-image sensor system 4036. Monitoring system 404 may include various sub-systems necessary for implementing the steps of the methods of one or both of FIGS. 2 and 3.

In an embodiment, monitoring system 404 includes baseline eye openness assessment controller 4042, real-time eye openness assessment controller 4044, non-image sensor data assessment controller 4046, eye based driver attentiveness determination controller 4048, non-eye based driver attentiveness determination controller 4050 and mode selection controller 4052.

Baseline eye openness assessment controller 4042 comprises a processer implemented controller configured to implement the steps of (i) acquiring at least one baseline eye image of a vehicle driver, and/or (ii) determining baseline eye openness of the vehicle driver, based on image information within the at least one baseline eye image, as required in connection with step 204 of the method of FIG. 2 or step 306 of the method of FIG. 3.

Real-time eye openness assessment controller 4044 comprises a processer implemented controller configured to implement the step of determining real time eye openness of a vehicle driver based on image information within an acquired set of real-time images—as part of method step 206 within the method of FIG. 2.

Non-image sensor data assessment controller 4046 comprises a processer implemented controller configured to acquire driver state information or driver alertness information from one or more non-image sensors 4032 for implementing a second (non-image data based) driver monitoring mode—when the second driver monitoring mode is selected in accordance with any of method step 304 or method step 310 of the method of FIG. 3.

Eye based driver attentiveness determination controller 4048 comprises a processer implemented controller configured to determine a difference value representing a difference between a real time eye openness of a vehicle driver and a determined baseline eye openness of the vehicle driver—in accordance with step 206 of the method of FIG. 2. Eye based driver attentiveness determination controller 4048 may additionally be configured to generate a data signal triggering a state change, in response to determining that the difference value is greater than a threshold value—in accordance with step 208 of the method of FIG. 2.

Non-eye based driver attentiveness determination controller 4050 comprises a processer implemented controller configured to determine attentiveness or alertness of a vehicle driver based on non-image sensor data received from non-image sensor system 4036—for example, in response to selection of a second driver monitoring mode, at any of step 304 or step 310 of the method of FIG. 3.

Mode selection controller 4052 comprises a processor implemented controller configured to select between a first driver monitoring mode and a second driver monitoring mode in accordance with any of method step 304 or method step 310 of the method of FIG. 3.

Event response control system 406 is a processor implemented control system communicably coupled with monitoring system 404—and which is configured to respond to one or more events or states detected by monitoring system 404 with one or more defined event responses. In an embodiment, event response control system 406 may be configured to respond to a determination (based on any of eye-data parameters, non-eye data parameters, image sensor derived parameters and/or non-image sensor derived parameters) that a vehicle driver is insufficiently alert or attentive or is un-alert or un-attentive by raising an appropriate alarm or taking remedial action. For example, if driver is detected to be drowsy and also does not respond to an alarm, the autopilot system of the vehicle may take over the vehicle driving control and park the vehicle safely. In various specific embodiments, event response control system 406 may be configured to respond to a determination that a vehicle driver is insufficiently alert or attentive or is un-alert or un-attentive by triggering a remedial state change comprising any of (i) a change from a non-alarm state to an alarm state, (ii) a change from an engine-on state to an engine-off state, (iii) change to a vehicle deceleration or a vehicle braking state, or (iv) change from one of a vehicle autopilot engaged state or a vehicle autopilot disengaged state to the other of the vehicle autopilot engaged state or a vehicle autopilot disengaged state.

The invention additionally provides a computer program product for monitoring a degree of attentiveness for a driver of a vehicle, comprising a non-transitory computer readable medium having a computer readable program code embodied therein, the computer readable program code comprising instructions for implementing any one or more of the methods described hereinabove.

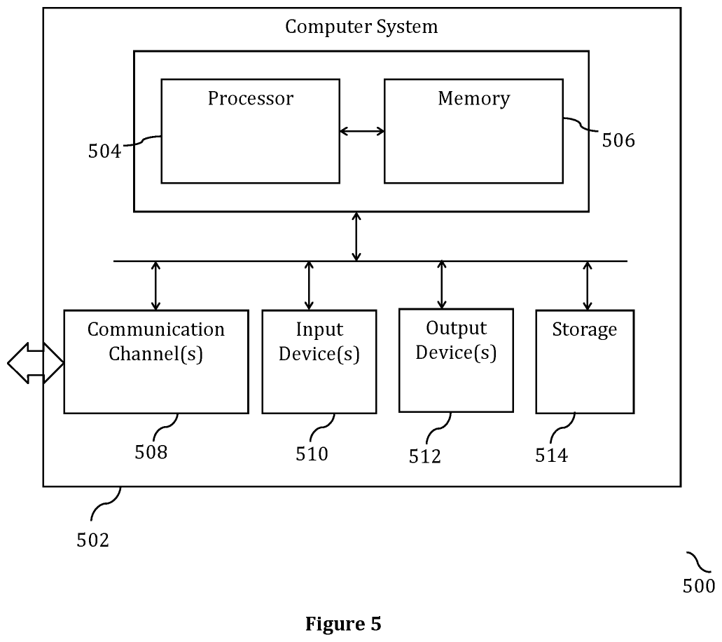

FIG. 5 illustrates an exemplary system for implementing the present invention. FIG. 5 illustrates an exemplary system 500 for implementing the present invention. The illustrated system 500 comprises computer system 502 which in turn comprises one or more processors 504 and at least one memory 506. Processor 504 is configured to execute program instructions—and may be a real processor or a virtual processor. It will be understood that computer system 502 does not suggest any limitation as to scope of use or functionality of described embodiments. The computer system 502 may include, but is not be limited to, one or more of a general-purpose computer, a programmed microprocessor, a micro-controller, an integrated circuit, and other devices or arrangements of devices that are capable of implementing the steps that constitute the method of the present invention. Exemplary embodiments of a computer system 502 in accordance with the present invention may include one or more servers, desktops, laptops, tablets, smart phones, mobile phones, mobile communication devices, tablets, phablets and personal digital assistants. In an embodiment of the present invention, the memory 506 may store software for implementing various embodiments of the present invention. The computer system 502 may have additional components. For example, the computer system 502 may include one or more communication channels 508, one or more input devices 510, one or more output devices 512, and storage 514. An interconnection mechanism (not shown) such as a bus, controller, or network, interconnects the components of the computer system 502. In various embodiments of the present invention, operating system software (not shown) provides an operating environment for various softwares executing in the computer system 502 using a processor 504, and manages different functionalities of the components of the computer system 502.

The communication channel(s) 508 allow communication over a communication medium to various other computing entities. The communication medium provides information such as program instructions, or other data in a communication media. The communication media includes, but is not limited to, wired or wireless methodologies implemented with an electrical, optical, RF, infrared, acoustic, microwave, Bluetooth or other transmission media.

The input device(s) 510 may include, but is not limited to, a touch screen, a keyboard, mouse, pen, joystick, trackball, a voice device, a scanning device, or any another device that is capable of providing input to the computer system 502. In an embodiment of the present invention, the input device(s) 510 may be a sound card or similar device that accepts audio input in analog or digital form. The output device(s) 512 may include, but not be limited to, a user interface on CRT, LCD, LED display, or any other display associated with any of servers, desktops, laptops, tablets, smart phones, mobile phones, mobile communication devices, tablets, phablets and personal digital assistants, printer, speaker, CD/DVD writer, or any other device that provides output from the computer system 502.

The storage 514 may include, but not be limited to, magnetic disks, magnetic tapes, CD-ROMs, CD-RWs, DVDs, any types of computer memory, magnetic stripes, smart cards, printed barcodes or any other transitory or non-transitory medium which can be used to store information and can be accessed by the computer system 502. In various embodiments of the present invention, the storage 514 may contain program instructions for implementing any of the described embodiments.

In an embodiment of the present invention, the computer system 502 is part of a distributed network or a part of a set of available cloud resources.

The present invention may be implemented in numerous ways including as a system, a method, or a computer program product such as a computer readable storage medium or a computer network wherein programming instructions are communicated from a remote location.

The present invention may suitably be embodied as a computer program product for use with the computer system 502. The method described herein is typically implemented as a computer program product, comprising a set of program instructions that is executed by the computer system 502 or any other similar device. The set of program instructions may be a series of computer readable codes stored on a tangible medium, such as a computer readable storage medium (storage 514), for example, diskette, CD-ROM, ROM, flash drives or hard disk, or transmittable to the computer system 502, via a modem or other interface device, over either a tangible medium, including but not limited to optical or analogue communications channel(s) 508. The implementation of the invention as a computer program product may be in an intangible form using wireless techniques, including but not limited to microwave, infrared, Bluetooth or other transmission techniques. These instructions can be preloaded into a system or recorded on a storage medium such as a CD-ROM, or made available for downloading over a network such as the Internet or a mobile telephone network. The series of computer readable instructions may embody all or part of the functionality previously described herein.

The invention accordingly implements driver monitoring systems that provide solutions for normalizing such variations and for providing an assessment of a degree of eye openness that accounts for such variations. The invention additionally provides solutions for providing effective driver monitoring in situations where due to facial characteristics, an individual's eye has a relatively lower degree of openness even in an alert or awake state, such that the visible area of the subject's eye even in a fully open state may be insufficient for the purposes of real time driver monitoring.

While the exemplary embodiments of the present invention are described and illustrated herein, it will be appreciated that they are merely illustrative. It will be understood by those skilled in the art that various modifications in form and detail may be made therein without departing from or offending the scope of the invention as defined by the appended claims. Additionally, the invention illustratively disclose herein suitably may be practiced in the absence of any element which is not specifically disclosed herein—and in a particular embodiment specifically contemplated, is intended to be practiced in the absence of any element which is not specifically disclosed herein.

What is claimed is:

1. A method for monitoring a degree of attentiveness for a driver of a vehicle, the method comprising:
detecting a predefined vehicle operation event;
responsive to detecting the predefined vehicle operation event, initiating a session specific driver enrolment process for the driver, comprising:
acquiring at least one baseline eye image of the driver;
determining baseline eye openness of the driver based on image information within the at least one baseline eye image;
prior to detection of a predefined session termination event:
acquiring a set of images of the driver;
determining real time eye openness of the driver based on image information within the acquired set of images;
determining a difference value representing a difference between the real time eye openness of the driver and the baseline eye openness of the driver; and
generating a data signal triggering a state change in response to determining that the difference value is greater than a threshold value.

2. The method as claimed in claim 1, wherein the at least one baseline eye image is acquired by an image sensor within a defined duration from detection of the predefined operation event.

3. The method as claimed in claim 1, wherein the predefined vehicle operation event is any one of a vehicle ignition event, a vehicle autopilot or cruise control mode engagement event, a driver seat occupation event, changing gear or driving mode, changing settings, interacting with map or infotainment system, the driver opening a driver-side door to enter the vehicle, the driver closing the driver's-side door after occupying the driver's seat, the driver engaging the gear shift for the first time after engine ignition or after occupying the driver's seat, or the driver engaging the accelerator or brake for the first time after engine ignition or after occupying the driver's seat.

4. The method as claimed in claim 1, wherein the predefined session termination event is any one of a vehicle engine shut-off event, a vehicle autopilot mode disengagement event, a driver's seat vacation event, the driver opening the vehicle's driver-side door to exit the vehicle, the driver vacating a driver's seat, the driver closing the driver's-side door after vacating the driver's seat, the driver disengaging the gear shift prior to shutting off the vehicle engine or prior to vacating the driver's seat, or the driver engaging the brake prior to shutting off the vehicle engine.

5. The method as claimed in claim 1, wherein the state change triggered by the data signal comprises any of (i) change from a non-alarm state to an alarm state, (ii) change from an engine-on state to an engine-off state, (iii) change to a vehicle deceleration or a vehicle braking state, or (iv) change from one of a vehicle autopilot engaged state or a vehicle autopilot disengaged state to the other of the vehicle autopilot engaged state or a vehicle autopilot disengaged state.

6. A method for monitoring a degree of attentiveness for a driver of a vehicle, the method comprising:
detecting a predefined vehicle operation event;
responsive to detecting the predefined vehicle operation event, initiate a session specific driver enrolment process for the driver, comprising:
acquiring at least one baseline image of the driver, and responding to determining that the at least one baseline image complies with a set of predefined requirements by:
determining baseline eye openness of the driver based on the eye image information within the at least one baseline image;
determining a difference value representing a difference between the baseline eye openness of the driver and a threshold value for eye openness of the driver; and
selecting between a first driver monitoring mode and a second driver monitoring mode, wherein the selection is based on the difference value;
wherein in the first driver monitoring mode, driver alertness is determined based on image characteristics corresponding to the driver's eye; and
in the second driver monitoring mode, driver alertness is determined based on one or more detected non-eye related characteristics of the driver.

7. The method as claimed in claim 6, comprising responding to determining that the at least one baseline image does not comply with the set of predefined requirements, by implementing the second driver monitoring mode.

8. The method as claimed in claim 6, wherein the at least one baseline image is acquired by an image sensor within a defined duration from detection of the predefined operation event.

9. The method as claimed in claim 6, wherein the predefined operation event is any one of a vehicle ignition event, a vehicle autopilot mode engagement event, a driver seat occupation event, changing gear or driving mode, changing settings, interacting with map or infotainment system, the driver opening a driver-side door to enter the vehicle, the driver closing the driver's-side door after occupying the driver's seat, the driver engaging the gear shift for the first time after engine ignition or after occupying the driver's seat, or the driver engaging the accelerator or brake for the first time after engine ignition or after occupying the driver's seat.

10. The method as claimed in claim 6, wherein the non-eye related characteristics of the driver includes one or more of head motion, mouth movement, heart rate, pulse rate, respiration rate, capacitive sensor response, electrocardiograph response, and galvanic skin response,

11. The method as claimed in claim 6, wherein responsive to selection of the first driver monitoring mode, the method comprises implementing, prior to detection of a predefined session termination event, the steps of:
acquiring a set of images of the driver;
determining real time eye openness of the driver based on image information within the acquired set of images;
determining a difference value representing a difference between the real time eye openness of the driver and the baseline eye openness of the driver; and
generating a data signal triggering a state change in response to determining that the difference value is greater than a threshold value.

12. The method as claimed in claim 11, wherein the predefined session termination event is any one of a vehicle engine shut-off event, a vehicle autopilot mode disengagement event, a driver's seat vacation event, the driver opening the vehicle's driver-side door to exit the vehicle, the driver vacating a driver's seat, the driver closing the driver's-side door after vacating the driver's seat, the driver disengaging the gear shift prior to shutting off the vehicle engine or prior to vacating the driver's seat, or the driver engaging the brake prior to shutting off the vehicle engine.

13. The method as claimed in claim 11, wherein the state change triggered by the data signal comprises any of (i) change from a non-alarm state to an alarm state, (ii) change from an engine-on state to an engine-off state, (iii) change to a vehicle deceleration or a vehicle braking state, or (iv) change from one of a vehicle autopilot engaged state or a vehicle autopilot disengaged state to the other of the vehicle autopilot engaged state or a vehicle autopilot disengaged state.

14. The method as claimed in claim 6, wherein responsive to selection of the second driver monitoring mode, the method comprises implementing, prior to detection of a predefined session termination event, the steps of:
acquiring data representing non-eye related characteristics of the driver;
determining based on the acquired data, one or more alertness parameters corresponding to the driver, wherein the non-eye related characteristics of the driver includes one or more of head motion, mouth movement, heart rate, pulse rate, respiration rate, capacitive sensor response, electrocardiograph response, and galvanic skin response; and
generating a data signal triggering a state change based on one or more of the determined alertness parameters.

15. A system for monitoring a degree of attentiveness for a driver of a vehicle, the system comprising:
a memory; and
a processor configured for:
detecting a predefined vehicle operation event;
responsive to detecting the predefined vehicle operation event, initiating a session specific driver enrolment process for the driver, comprising:
acquiring at least one baseline eye image of the driver;
determining baseline eye openness of the driver based on image information within the at least one baseline eye image;
prior to detection of a predefined session termination event:
acquiring a set of images of the driver;
determining real time eye openness of the driver based on image information within the acquired set of images;
determining a difference value representing a difference between the real time eye openness of the driver and the baseline eye openness of the driver; and
generating a data signal triggering a state change in response to determining that the difference value is greater than a threshold value.

16. The system as claimed in claim 15 configured such that at least one baseline eye image is acquired by an image sensor within a defined duration from detection of the predefined operation event.

17. The system as claimed in claim 15 configured such that, the predefined operation event is any one of a vehicle ignition event, a vehicle autopilot mode engagement event, a driver's seat occupation event, the driver opening a driver-side door to enter the vehicle, the driver closing the driver's-side door after occupying the driver's seat, the driver engaging the gear shift for the first time after engine ignition or after occupying the driver's seat, or the driver engaging the accelerator or brake for the first time after engine ignition or after occupying the driver's seat.

18. The system as claimed in claim 15 configured such that the predefined session termination event is any one of a vehicle engine shut-off event, a vehicle autopilot mode disengagement event, a driver's seat vacation event, the driver opening the vehicle's driver-side door to exit the vehicle, the driver vacating a driver's seat, the driver closing the driver's-side door after vacating the driver's seat, the driver disengaging the gear shift prior to shutting off the vehicle engine or prior to vacating the driver's seat, or the driver engaging the brake prior to shutting off the vehicle engine.

19. The system as claimed in claim 15 configured such that, the state change triggered by the data signal comprises any of (i) change from a non-alarm state to an alarm state, (ii) change from an engine-on state to an engine-off state, (iii) change to a vehicle deceleration or a vehicle braking state, or (iv) change from one of a vehicle autopilot engaged state or a vehicle autopilot disengaged state to the other of the vehicle autopilot engaged state or a vehicle autopilot disengaged state.
